(19) United States
(12) Patent Application Publication
(10) Pub. No.: US 2016/0105131 A1
(43) Pub. Date: Apr. 14, 2016

(54) VIBRATION GENERATING DEVICE

(71) Applicant: SAMSUNG ELECTRO-MECHANICS CO., LTD., Suwon-si (KR)

(72) Inventor: Hwa Young OH, Suwon-si (KR)

(73) Assignee: SAMSUNG ELECTRO-MECHANICS CO., LTD., Suwon-si (KR)

(21) Appl. No.: 14/626,034

(22) Filed: Feb. 19, 2015

(30) Foreign Application Priority Data
Oct. 8, 2014 (KR) 10-2014-0136010

(51) Int. Cl. H02N 2/00

(52) U.S. Cl. CPC H02N 2/001; H02N 2/006

(57) ABSTRACT

There is provided a vibration generating device including: a housing having an internal space; a first vibrating part having one end which is fixed to one end of the housing to be a fixed end and the other end which is a free end; a second vibrating part disposed to face the first vibrating part and having one end which is fixed to the other end of the housing to be a fixed end and the other end which is a free end; and a mass body having one end which is fixed to the free end of the first vibrating part and the other end which is fixed to the free end of the second vibrating part to be vibrated vertically by the first and second vibrating parts.

### CROSS-REFERENCE TO RELATED APPLICATION

This application claims the priority and benefit of Korean Patent Application No. 10-2014-0136010 filed on Oct. 8, 2014, with the Korean Intellectual Property Office, the disclosure of which is incorporated herein by reference.

### BACKGROUND

The present disclosure relates to a vibration generating device.

Vibration generating devices, converting electric energy into mechanical vibrations through the generation of electromagnetic force, has commonly been mounted in mobile phones, and the like, in order to silently notify users of call reception by transferring vibrations thereto.

Meanwhile, recently, a vibration generating device using a piezoelectric element has been used. Such a vibration generating device using a piezoelectric element, relying on the principle of an inverse piezoelectric effect in which displacement is generated when voltage is applied to the piezoelectric element, uses the principle of allowing a mass body of a vibrator to be moved by the displacement generated by the piezoelectric element to generate vibration force.

Here, the piezoelectric element generally has a rectangular parallelepiped shape in which a length thereof is greater than a width thereof. However, in this case, since the piezoelectric element should be relatively long in order to secure displacement and vibrations, an overall length of the vibration generating device is increased, such that there are limitations in making the vibration generating device miniaturized and thinned.

[Related Art Document]

(Patent Document 1) Japanese Patent Laid-Open Publication No. 2012-200077

### SUMMARY

An aspect of the present disclosure may provide a miniaturized and thinned vibration generating device.

According to an aspect of the present disclosure, a vibration generating device may include: a housing having an internal space; a first vibrating part having one end which is fixed to one end of the housing to be a fixed end and the other end which is a free end; a second vibrating part disposed to face the first vibrating part and having one end which is fixed to the other end of the housing to be a fixed end and the other end which is a free end; and a mass body having one end which is fixed to the free end of the first vibrating part and the other end which is fixed to the free end of the second vibrating part to be vibrated vertically by the first and second vibrating parts.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a schematic perspective view of a vibration generating device according to an exemplary embodiment of the present disclosure;

FIG. 2 is an exploded perspective view of the vibration generating device according to an exemplary embodiment of the present disclosure;

FIG. 3 is an exploded perspective view of a first vibrating part and a mass body of the vibration generating device according to an exemplary embodiment of the present disclosure;

FIG. 4 is a schematic perspective view of a vibration generating device according to another exemplary embodiment of the present disclosure;

FIG. 5 is an exploded perspective view of the vibration generating device according to another exemplary embodiment of the present disclosure; and

FIG. 6 is an exploded perspective view of amass body and a damper member of the vibration generating device according to another exemplary embodiment of the present disclosure.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

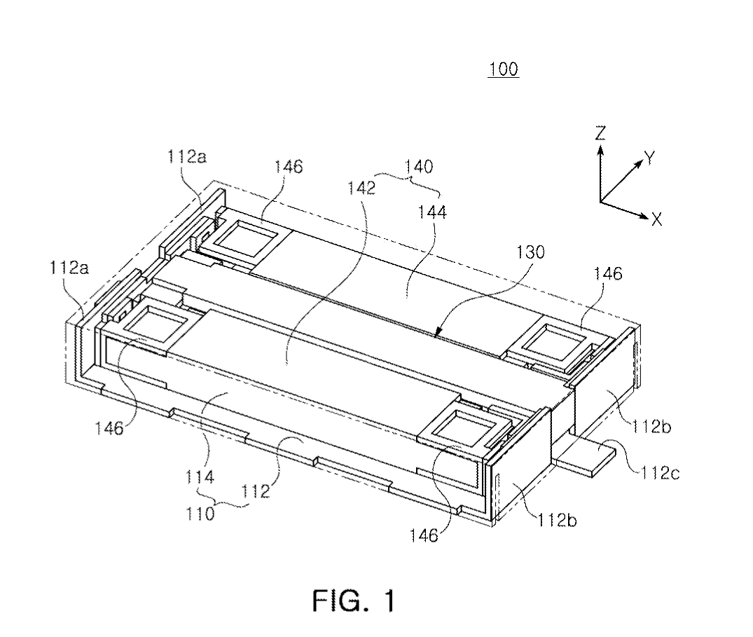

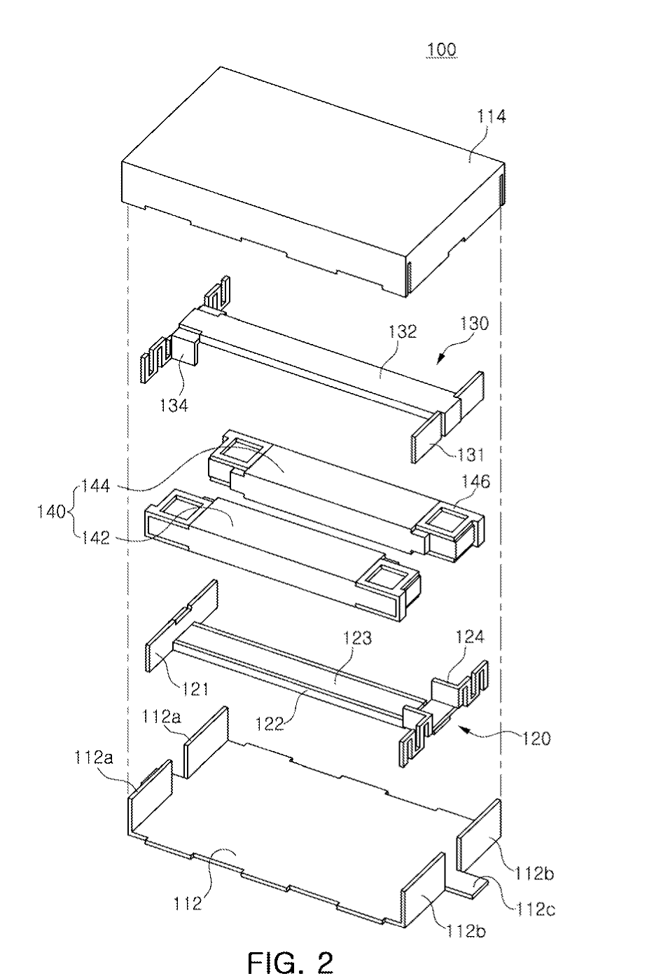

FIG. 1 is a schematic perspective view showing a vibration generating device according to an exemplary embodiment of the present disclosure; and FIG. 2 is an exploded perspective view showing the vibration generating device according to an exemplary embodiment of the present disclosure.

Referring to FIGS. 1 and 2, a vibration generating device 100 according to an exemplary embodiment of the present disclosure may include a housing 110, a first vibrating part 120, a second vibrating part 130, and a mass body 140 by way of example.

The housing 110 may have an internal space. That is, the housing 110 may have the internal space so that the first vibrating part 120, the second vibrating part 130, and the mass body 140 may be installed therein.

Meanwhile, the housing 110 may include a bracket 112 and a case 114.

The bracket 112 may have a plate shape and have first and second support plates 112a and 112b formed at both end portions thereof. The first support plate 112a may be formed of two bent portions, and two first support plates 112a may be disposed to be spaced apart from each other by a predetermined interval. Meanwhile, the two first support plates 112a may have a board seating part 112c formed therebetween in order to seat a circuit board (not shown) at the time of withdrawing the circuit board.

In addition, the second support plate 112b may also be formed of two bent portions, and two second support plates 112b may also be disposed to be spaced apart from each other by a predetermined interval.

The case 114 may form, together with the bracket 112, the internal space, and the bracket 112 may be coupled to a lower end portion of the case 114. Meanwhile, the case 114 may have a box shape in which a lower portion of a rectangular parallelepiped shape is opened.

As described above, the housing 110 may have the rectangular parallelepiped shape having the internal space.

As an example, the housing 110 may have a length of 10 to 20 mm, a width of 6 to 10 mm, and a thickness of 2.5 to 3 mm.

However, the present disclosure is not limited thereto. That is, the housing 110 may have various shapes and sizes.

Here, terms with respect to a length direction, a width direction, and a thickness direction will be defined. As viewed in FIG. 1, the length direction refers to an X direction, the width direction refers to a Y direction, and the thickness direction refers to a Z direction.

The first vibrating part 120 may have one end which is fixed to one end of the housing 110 to be a fixed end and the other end which is a free end. That is, the first vibrating part 120 may have a cantilever shape.

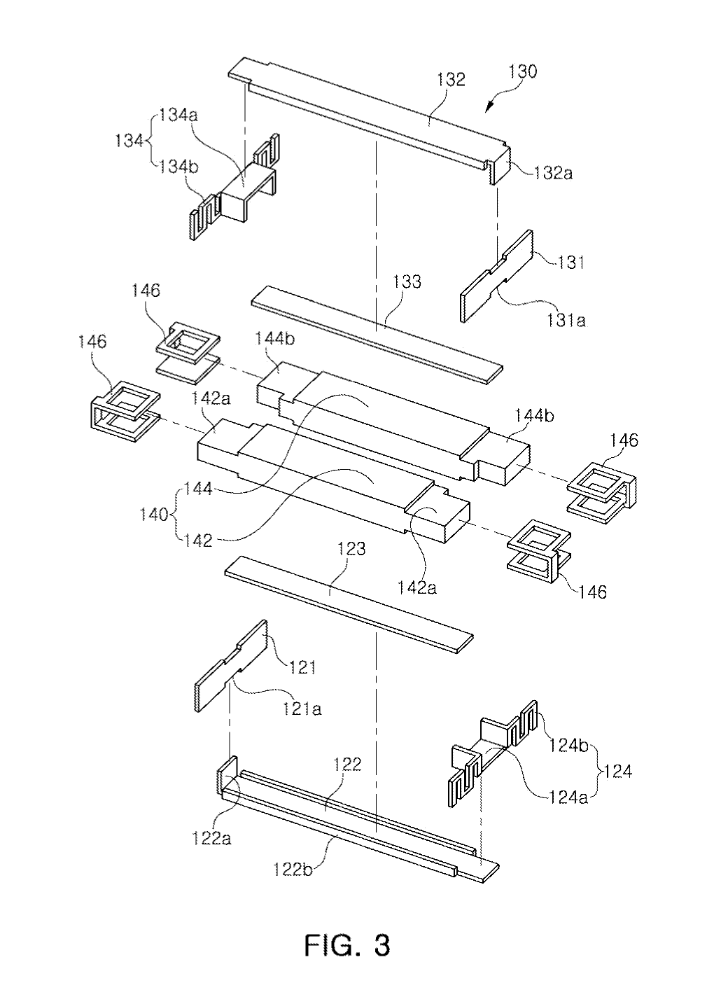

Meanwhile, the first vibrating part 120 may include a first installation member 121, a first vibrating member 122, a first piezoelectric element 123, and a first spring member 124, as shown in more detail in FIG. 3.

The first installation member 121 may have a plate shape and have one end fixed to the housing 110. As an example, the first installation member 121 may be fixed to the first support plates 112a of the bracket 112. In addition, the first installation member 121 may have assembling grooves 121a formed therein to be coupled to the first vibrating member 122.

In addition, the first vibrating member 122 may have one end fixed to the first installation member 121 and be disposed to be directed toward the other end of the housing 110. As an example, the first vibrating member 122 may be disposed in the length direction and have one end which is fixed to the first installation member 121 and the other end which is a free end.

Meanwhile, the first vibrating member 122 may have a first bent portion 122a formed at one end thereof and have second bent portions 122b formed at both side surfaces thereof, wherein the first bent portion 122a is bonded to the first installation member 121 and the second bent portions 122b support both side surfaces of the first piezoelectric element 123.

As described above, since one end of the first vibrating member 122 is fixedly installed to be a fixed end and the other end thereof is the free end, the other end of the first vibrating member 122 may vibrate at the time of deformation of the first piezoelectric element 123.

The first piezoelectric element 123 may be installed on an upper surface of the first vibrating member 122 so that both side surfaces thereof are supported by the second bent portions 122b. In addition, the first piezoelectric element 123 may have a bar shape corresponding to a shape of the first vibrating member 122. Further, the circuit board (not shown) may be connected to the first piezoelectric element 123.

As described above, in the case in which power is applied to the first piezoelectric element 123, the first vibrating member 122 may vibrate by deformation of the first piezoelectric element 123. That is, one end of the first vibrating member 122 may be fixed, and the other end thereof may vertically vibrate.

The first spring member 124 may be installed at the other end of the first vibrating member 122. The first spring member 124 may include a first bonded portion 124a bonded to the other end of the first vibrating member 122 and first elastic deformation portions 124b extended from both side surfaces of the first bonded portion 124a in the width direction. Meanwhile, the first elastic deformation portions 124b may be deformed to be bent in a horizontal direction to allow the mass body 140 to vertically vibrate.

The second vibrating part 130 may have one end which is fixed to the other end of the housing 110 to be a fixed end and the other end which is a free end, and may be disposed to face the first vibrating part 120. That is, the second vibrating part 130 may also have a cantilever shape and be disposed in the housing 110 to face the first vibrating part 120.

Meanwhile, the second vibrating part 130 may include a second installation member 131, a second vibrating member 132, a second piezoelectric element 133, and a second spring member 134.

The second installation member 131 may have a plate shape and have one end fixed to the housing 110. As an example, the second installation member 131 may be fixed to the second support plates 112b of the bracket 112. In addition, the second installation member 131 may have assembling grooves 131a formed therein to be coupled to the second vibrating member 132.

In addition, the second vibrating member 132 may have one end fixed to the second installation member 131 and be disposed to be directed toward the other end of the housing 110. As an example, the second vibrating member 132 may be disposed in the length direction and have one end which is fixed to the second installation member 131 to be a fixed end and the other end which is a free end. In addition, the second vibrating member 132 may be fixed to the second installation member 131 to be disposed above the second installation member 131.

Meanwhile, the second vibrating member 132 may have a third bent portion 132a formed at one end thereof and have fourth bent portions 132b formed at both side surfaces thereof, wherein the third bent portion 132a is bonded to the second installation member 131 and the fourth bent portions 132b support both side surfaces of the second piezoelectric element 133.

As described above, since one end of the second vibrating member 132 is fixedly installed to be the fixed end and the other end thereof is the free end, the other end of the second vibrating member 132 may vibrate at the time of deformation of the second piezoelectric element 133.

The second piezoelectric element 133 may be installed on a lower surface of the second vibrating member 132 so that both side surfaces thereof are supported by the fourth bent portions 132b. In other words, the second piezoelectric element 133 may be installed on the lower surface of the second vibrating member 132 to face the first piezoelectric element 123.

In addition, the second piezoelectric element 133 may also have a bar shape like the first piezoelectric element 123. In addition, the second piezoelectric element 133 may also be connected to the circuit board although not shown in the accompanying drawings.

As described above, since the second piezoelectric element 133 is installed below the second vibrating member 132, the second vibrating member 132 may vibrate by deformation of the second piezoelectric element 133. That is, one end of the second vibrating member 132 may be fixed, and the other end thereof may vertically vibrate.

The second spring member 134 may be installed at the other end of the second vibrating member 132. The second spring member 134 may include a second bonded portion 134a bonded to the other end of the second vibrating member 132 and second elastic deformation portions 134b extended from both side surfaces of the second bonded portion 134a in the width direction. Meanwhile, the second elastic deformation portions 134b may be deformed to be bent in the horizontal direction to allow the mass body 140 to vertically vibrate.

The mass body 140 may have one end fixed to the free end of the first vibrating part 120 and the other end fixed to the free end of the second vibrating part 130 to be vibrated vertically by the first and second vibrating parts.

In more detail, the mass body 140 may include first and second weight bodies 142 and 144. In addition, the first mass body 142 may be disposed at one sides of the first and second vibrating parts 120 and 130, and the second mass body 144 may be disposed at the other sides of the first and second vibrating parts 120 and 130. That is, one end of the first mass body 142 may be fixed to one side of the first spring member 124, and the other end thereof may be fixed to one side of the second spring member 134. In addition, one end of the second mass body 144 may be fixed to the other side of the first spring member 124, and the other end thereof may be fixed to the other side of the second spring member 134.

Meanwhile, the first and second weight bodies 142 and 144 may have holders 146 formed at both end portions thereof, wherein the holders 146 are bonded to the first and second spring members 124 and 134. That is, the holders 146 installed at the first and second weight bodies 142 and 144 may be bonded to the first and second spring members 124 and 134.

In addition, the first and second weight bodies 142 and 144 may have step portions 142a and 144a formed at both end portions thereof in order to install the holders 146.

Next, an operation of the vibration generating device 100 according to an exemplary embodiment of the present disclosure will be described.

When power is applied to the first piezoelectric element 123 of the first vibrating part 120, the other end of the first vibrating member 122 may be vibrated vertically by the deformation of the first piezoelectric element 123. In addition, the first spring member 124 installed at the other end of the first vibrating member 122 may also vertically vibrate together with the first vibrating member 122.

Meanwhile, in the case in which only the first vibrating part 120 is included in the vibrating generating device 100 and the mass body 140 is installed at the first spring member 124 of the first vibrating member 120, the mass body 140 does not vertically vibrate, but may rotate. In this case, vertical movement of the mass body 140 may not be uniform, which causes a decrease in a vibration amount.

However, in the vibration generating device 100 according to an exemplary embodiment of the present disclosure, the first and second vibrating parts 120 and 130 may be disposed to face each other, and the first and second spring members 124 and 134 may serve to allow the mass body 140 to vibrate in a vertical direction.

That is, one end of the first vibrating part 120 may be fixed to one end of the housing 110 to be the fixed end, and the other end thereof may be disposed at the other end of the housing 110 to be the free end. In addition, one end of the second vibrating part 120 may be fixed to the other end of the housing 110 to be the fixed end, and the other end thereof may be disposed at one end of the housing 110 to be the free end. The mass body 140 may be installed at the first and second vibrating parts 120 and 130 disposed as described above.

Therefore, the mass body 140 may smoothly vibrate in the vertical direction to prevent a decrease in a vibration amount.

As a result, vibrations may be generated from the first and second vibrating parts 120 and 130 disposed to face each other, whereby the vibration generating device may be miniaturized and thinned.

Meanwhile, a resonant frequency by the first and second vibrating parts 120 and 130 and the mass body 140 may be approximately 150 to 250 Hz.

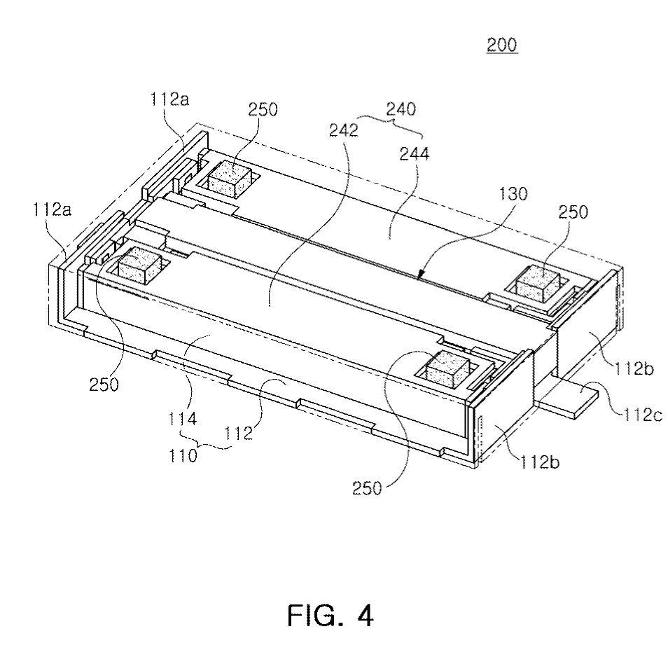

Hereinafter, a vibration generating device according to another exemplary embodiment of the present disclosure will be described with reference to FIGS. 4 through 6. However, the same components as the above-mentioned components will be denoted by the same reference numerals and a detailed description therefor will be omitted.

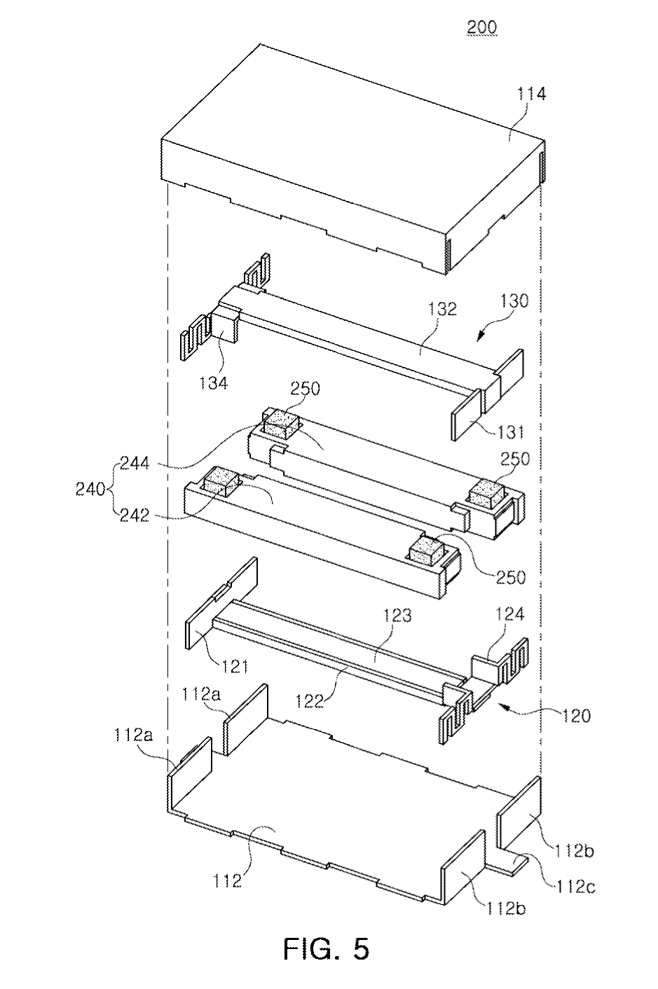

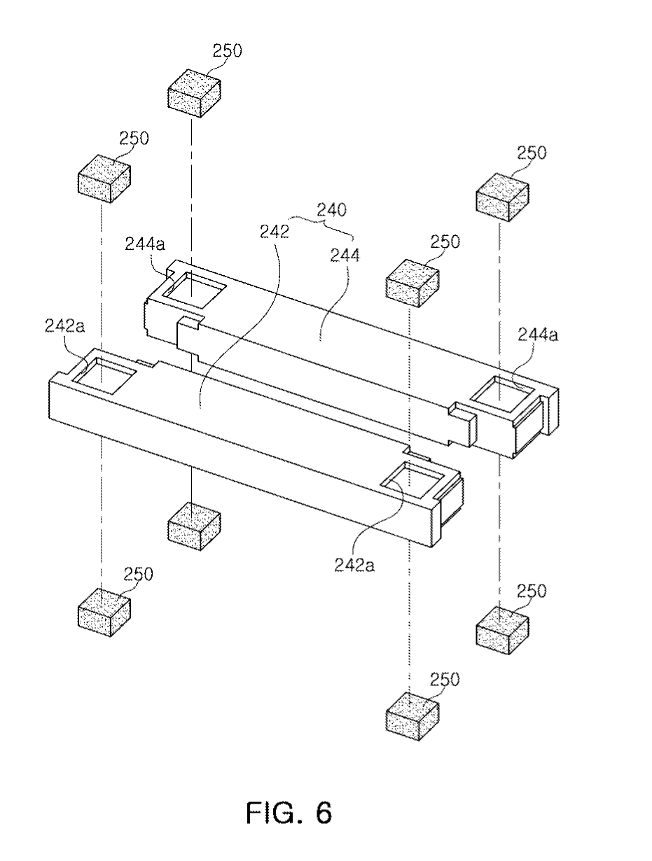

FIG. 4 is a schematic perspective view showing a vibration generating device according to another exemplary embodiment of the present disclosure; FIG. 5 is an exploded perspective view showing the vibration generating device according to another exemplary embodiment of the present disclosure; and FIG. 6 is an exploded perspective view showing a mass body and a damper member of the vibration generating device according to another exemplary embodiment of the present disclosure.

Referring to FIGS. 4 through 6, a vibration generating device 200 according to another exemplary embodiment of the present disclosure may include a housing 110, a first vibrating part 120, a second vibrating part 130, amass body 240, and damper members 250.

Meanwhile, since the housing 110 and the first and second vibrating parts 120 and 130 are the same as the above-mentioned components, a detailed description therefor will be omitted.

The mass body 240 may include first and second weight bodies 242 and 244 and have both end portions directly fixed to the first and second spring members 124 and 134. That is, the first and second weight bodies 242 and 244 may be directly fixed to the first and second spring members 124 and 134 without the holders 146 of the vibration generating device 100 according to an exemplary embodiment of the present disclosure described above.

Meanwhile, the first and second weight bodies 242 and 244 may have installation grooves 242a and 244a formed in both end portions of upper and lower surfaces thereof, wherein the installation grooves 242a and 244a have the damper members 250 inserted thereinto.

The damper members 250 may be fixedly installed in the installation grooves 242a and 244a of the first and second weight bodies 242 and 244 and prevent generation of noise due to a contact between the first and second weight bodies 242 and 244 and the housing 110 generated at the time of vibration of the first and second weight bodies 242 and 244.

Further, the damper members 250 may absorb an impact amount applied at the time of external impact to prevent damage to the first and second weight bodies 242 and 244 and the housing 110.

As an example, the damper members 250 may have a cubic shape, and four damper members 250 may be installed in each of the first and second weight bodies 242 and 244. However, the present disclosure is not limited thereto. That is, shapes of the damper members 250 and the number of damper members 250 may be modified.

In addition, although the case in which the damper members 250 are installed on the upper and lower surfaces of the first and second weight bodies 242 and 244 has been described by way of example in the present exemplary embodiment, the damper members 250 may also be installed on both side surfaces and both end surfaces of the first and second weight bodies 242 and 244.

As described above, the generation of the noise and the damage to the weight bodies and the housing may be prevented through the damper members 250.

As set forth above, according to exemplary embodiments of the present disclosure, the vibration generating device may be miniaturized and thinned.

While exemplary embodiments have been shown and described above, it will be apparent to those skilled in the art that modifications and variations could be made without departing from the scope of the present invention as defined by the appended claims.

What is claimed is:

1. A vibration generating device comprising:
a housing having an internal space;
a first vibrating part having one end which is fixed to one end of the housing to be a fixed end and the other end which is a free end;
a second vibrating part disposed to face the first vibrating part and having one end which is fixed to the other end of the housing to be a fixed end and the other end which is a free end; and
a mass body having one end which is fixed to the free end of the first vibrating part and the other end which is fixed to the free end of the second vibrating part to be vibrated vertically by the first and second vibrating parts.

2. The vibration generating device of claim 1, wherein the first vibrating part includes:
a first installation member fixed to one end of the housing;
a first vibrating member of which one end is fixed to the first installation member and which is disposed to be directed toward the other end of the housing;
a first piezoelectric element fixedly installed on an upper surface of the first vibrating member; and
a first spring member installed on the other end of the first vibrating member.

3. The vibration generating device of claim 2, wherein the second vibrating part includes:
a second installation member fixed to the other end of the housing;
a second vibrating member of which one end is fixed to the second installation member and which is disposed to be directed toward one end of the housing;
a second piezoelectric element fixedly installed on an upper surface of the second vibrating member; and
a second spring member fixedly installed on the other end of the second vibrating member.

4. The vibration generating device of claim 3, wherein the mass body has one end which is fixed to the first spring member and the other end which is fixed to the second spring member, and
the first and second piezoelectric elements are disposed to face each other.

5. The vibration generating device of claim 3, wherein the first spring member includes a first bonded portion bonded to the other end of the first vibrating member and first elastic deformation portions extended from both side surfaces of the first bonded portion in a width direction of the first vibrating part, and
the second spring member includes a second bonded portion bonded to the other end of the second vibrating member and second elastic deformation portions extended from both side surfaces of the second bonded portion in a width direction of the second vibrating part.

6. The vibration generating device of claim 3, wherein the first vibrating member includes a first bent portion which is disposed at one end thereof and bonded to the first installation member and second bent portions which support both side surfaces of the first piezoelectric element, and
the second vibrating member includes a third bent portion which is disposed at one end thereof and bonded to the second installation member and fourth bent portions which support both side surfaces of the second piezoelectric element.

7. The vibration generating device of claim 3, further comprising a plurality of holders fixed to both end portions of the mass body and connected to the first and second spring members.

8. The vibration generating device of claim 7, wherein both end portions of the mass body are provided with step portions facilitating installation of the holders.

9. The vibration generating device of claim 1, further comprising a damper member installed on any one of both end portions of upper and lower surfaces of the mass body.

10. The vibration generating device of claim 1, wherein the housing includes:
a bracket including first and second support plates to which the first and second vibrating parts are bonded; and
a case coupled to the bracket to form a closed space.

11. A vibration generating device comprising:
a housing having an internal space;
a first vibrating part having one end which is fixed to one end of the housing to be a fixed end and the other end which is a free end;
a second vibrating part disposed to face the first vibrating part and having one end which is fixed to the other end of the housing to be a fixed end and the other end which is a free end; and
a mass body having one end which is fixed to a first spring member disposed at the free end of the first vibrating part and the other end which is fixed to a second spring member disposed at the free end of the second vibrating part to be vibrated vertically by the first and second vibrating parts,
wherein the first vibrating part includes a first piezoelectric element, and
the second vibrating part includes a second piezoelectric element.
